(19) United States
(12) Patent Application Publication
(10) Pub. No.: US 2026/0211382 A1
(43) Pub. Date: Jul. 23, 2026

(54) VALVE STICTION DETECTION FOR CLOSED-LOOP CONTROLLERS

(71) Applicant: Dow Global Technologies LLC, Midland, MI (US)

(72) Inventors: Ivan Castillo, Lake Jackson, TX (US); Rob Hoogerwerf, Hoek (NL); Chun-Yao Lien, Houston, TX (US); Alexander Smith, Madison, WI (US); Krystian Perez, Provo, UT (US); Leo H. Chiang, Lake Jackson, TX (US); Ashwani Gandhi, Hoek (NL); Zhenyu Wang, Lake Jackson, TX (US); Birgit Braun, Lake Jackson, TX (US)

(21) Appl. No.: 19/139,130

(22) PCT Filed: Dec. 13, 2023
(86) PCT No.: PCT/US2023/083914

§ 371 Date: Jun. 13, 2025

Related U.S. Application Data
(60) Provisional application No. 63/432,450, filed on Dec. 14, 2022.

(51) Int. Cl. G05B 13/02; G05D 7/06; G05D 9/12

(52) U.S. Cl. CPC G05B 13/027; G05D 7/0635; G05D 9/12

(57) ABSTRACT

Deep Convolutional Neural Networks (CNNs) can be used to identify a non-linear control valve event in a control loop of a chemical process. Identifying the non-linear control valve event can be based on a predetermined feature of a red, green and blue (RGB) image, where the RGB image is obtained by merging respective matrices assembled from continuous wavelet transform coefficients derived from chemical plant operation controller signals. Once the non-linear control valve event is identified in a control loop, controller settings can be modified to minimize the non-linear control valve event and/or a root cause investigation can be conducted to address the issue.

### TECHNICAL FIELD

The present disclosure relates to the identification of non-linear control valve events in a multivariate time series of data. Such techniques can be particularly useful to identify and notify an operator of a condition of a controller in a control valve loop of a chemical process for adjusting a setting of the controller to address the non-linear control valve event.

### BACKGROUND

Control loop performance monitoring can provide for safe and consistent operation of a chemical plant. There are, however, situations in which equipment performance issues can result in less than optimal performance of the chemical plant. For example, stiction is an equipment problem that causes resistance to proper valve movement and introduces a delay between the controller output and the valve stem position. When a control valve suffers from stiction, its stem may not move when the controller output changes, and this nonlinearity creates sustained oscillations in control loops.

Correctly identifying such issues like valve stiction in closed-loop controllers is a difficult task. Often time, a chemical plant can contain hundreds if not thousands of control loops having a controller. As valves controlled by each controller can be susceptible to stiction the likelihood of having to address this condition is certain to occur. As a result, there is a need in the art for the monitoring and assessing control loops to help improve chemical plant operations.

### SUMMARY OF THE DISCLOSURE

The present disclosure is directed to improvements in chemical plant operations by monitoring and assessing control loops for non-linear control valve events. Specifically, the present disclosure provides for a method and a system for identifying non-linear control valve events in a control loop of a chemical process. Identifying the non-linear control valve events is based on a predetermined feature of an RGB image, which is detected by a deep convolutional neural network (CNN) trained to identify the non-linear control valve events. For the various embodiments, such non-linear control valve events can include valve stiction, where identifying such non-linear control valve events can help to improve chemical plant operations.

As provided herein, a method of the present disclosure includes receiving a set point (SP) signal, a process variable (PV) signal, and a controller output (CO) signal comprising a multivariate time series of data from a control loop for a control valve of a chemical process, where the CO signal is received from a controller that controls a position of the control valve in the chemical process. The multivariate time series data coming from each of the SP signal, the PV signal and the CO signal is transformed utilizing a continuous wavelet transform (CWT) to provide respective CWT coefficients for each of the SP signal, the PV signal and the CO signal. The respective CWT coefficients are assembled into respective matrices, where the respective matrices are merged to provide a red, green, and blue (RGB) image. For the various embodiments, the RGB image is inputted into a deep convolutional neural network (CNN) trained to identify a non-linear control valve event in the control loop of the chemical process based on a predetermined feature of the RGB image. In response to the CNN identifying the predetermined feature, settings of the controller can be adjusted to minimize or eliminate the non-linear control valve event (e.g., stiction valve event). In addition, identifying the control valve issue allows for a further investigation into the root cause of the non-linear control valve event (e.g., a stiction problem) so that it can be addressed (e.g., corrected).

For the various embodiments, the multivariate time series of data is taken at a predetermined frequency over a predetermined time interval. For example, the non-linear control valve event can be an oscillation event. In a specific embodiment, the non-linear control valve event is the result of the valves being controlled by the controller being in a state of stiction. In additional embodiments, a variety of wavelets can be used in transforming the multivariate time series data utilizing the CWT. For example, a Morlet wavelet is used in transforming the multivariate time series data utilizing the CWT. For the various embodiments, transforming the comparison of at least one pair of the SP signal, the PV signal and the CO signal of the multivariate time series of data comprises transforming the multivariate time series of data without preprocessing the multivariate time series of data.

For the various embodiments, the CNN identifies the predetermined feature based on changes in frequency information from the time series multivariate signals. For example, the predetermined feature of the RGB image is related to dynamical frequency spectrum activations identified by the CNN once the non-linear control valve event is identified.

For the various embodiments, the CNN is pretrained to identify the non-linear control valve event in the RGB image, where the method further comprises training the CNN via transfer learning with a plurality of RGB images of comparisons of at least one pair of the SP signal, the PV signal and the CO signal of the multivariate time series of data for the controller from prior identified non-linear control valve events of the controller in the plurality of RGB images. In some embodiments, the CNN can be trained using RGB images based on signals, such as SP signals, PV signals, and CO signals, associated with different controllers (e.g., the training of the CNN need not be controller-specific).

For the various embodiments, the controller is a flow controller in the control loop of the chemical process. Alternatively, the controller could be a level controller, a temperature controller, or a pressure controller in the control loop in the chemical process.

Embodiments of the present disclosure also include a system that includes a detector, the CNN and a controller. The detector is configured to receive the SP signal, the PV signal, and the CO signal comprising the multivariate time series of data from the control loop for the control valve of the chemical process. The CNN is trained with a plurality of RGB images of comparisons of at least one pair of the SP signal, the PV signal, and the CO signal of the multivariate time series of data for the controller from prior identified non-linear control valve events of the controller in the plurality of RGB images. The controller is coupled to the detector and to the CNN, where the controller is configured to: convert the least one pair of the SP signal, the PV signal and the CO signal of the multivariate time series of data to a RGB image utilizing a CWT; input the RGB image to the CNN; identify a non-linear control valve event of the controller with the CNN; and adjust the setting of the controller to minimize or eliminate the non-linear control valve event of the controller identified by the CNN. For the adjustments, it is possible that an operator is made aware of the non-linear control valve event of the controller with the CNN at which point one or more of a further investigation into the root cause of the non-linear control valve event (e.g., a stiction problem) can start and/or adjustment to the setting of the controller can be made by the operator to minimize or eliminate the non-linear control valve event of the controller identified by the CNN. For the various embodiments, the controller is configured to convert the multivariate time series of data to the RGB image without preprocessing the multivariate time series of data.

For the various embodiments, the non-linear control valve event is the result of the valves controlled by the controller being in a state of stiction.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 provides an embodiment of a control loop of a chemical process for embodiments of the present disclosure.

FIGS. 2A-2D provide two controller examples of RGB images and feature maps by a CNN network when stiction is present (FIGS. 2A and 2B) and non-stiction (FIGS. 2C and 2D).

### DETAILED DESCRIPTION

The present disclosure is directed to improvements in chemical plant operations by monitoring and assessing control loops for non-linear control valve events. Specifically, the present disclosure provides for a method and a system for identifying non-linear control valve events in a control loop of a chemical process. The non-linear control valve events are based on a predetermined feature of an RGB image, which is identified by a deep convolutional neural network (CNN) trained to identify the non-linear control valve events. For the various embodiments, such non-linear control valve events can include valve stiction, where identifying and addressing (e.g., changing valve settings and/or replacing faulty equipment) such non-linear control valve events can help to improve chemical plant operations.

By way of background, a CNN is a type of deep neural network that can be used to identify patterns in images. For example, a CNN can be used to assign importance (learnable weights and biases) to various aspects/objects in an image and be able to differentiate one from the other. Such images can include so called three channel representation that have Red, Green and Blue elements (e.g., a RGB image), where the CNN uses a neural network to process the Red, Green and Blue elements of many signals simultaneously. The “deep” of the convolutional neural network refers to the use of multiple layers in the CNN, where these layers extract successively higher order features from a raw input. For image analysis, examples of such features of the RGB image include edges or color as low-level features, where the CNN can be trained through a combination of convolution and pooling, among other steps, to identify high-level features such as shapes and gradient orientation that allow for a fuller interpretation of the RGB image.

The RGB image, as provided herein, is derived from multiple non-stationary signals and/or time series signals using continuous wavelet transformation (CWT). CWT is useful in transforming these one-dimensional time series signals into coefficients that account for both scale and position of the signal all while being resistant to signal noise. Each CWT provides scaled and shifted versions of a wavelet function, the sum of which is taken over time to provide what is referred to as wavelet coefficients, which represent the time, frequency and characteristics of the signal. The wavelet coefficients, in turn, can be provided in a scalogram, which provides for the relative changes in both the time and frequency in highly resolved detail. Such detail allows for both pattern recognition and/or feature extraction with respect to the signal.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected and, unless stated otherwise, can include a wireless connection.

As will be appreciated, elements shown in the various embodiments herein can be added, exchanged, and/or eliminated to provide a number of additional embodiments of the present disclosure. In addition, as will be appreciated, the proportion and the relative scale of the elements provided in the figures are intended to illustrate certain embodiments of the present invention and should not be taken in a limiting sense.

As already noted, the present disclosure is directed to improvements in chemical plant operations by monitoring and assessing control loops for non-linear control valve events. Chemical plant in industries such as petroleum refineries, petrochemical industries, polymer industries, pulp and paper industries, power plants, pharmaceutical industries and the like have many control loops that help to maintain key process variables at their respective set points. Control loops are the building blocks of the chemical plant control system, and each include the physical components (e.g., control elements such as valves and sensors) and control functions (e.g., controllers) that work together to adjust each of the process variables to meet the desired set-point.

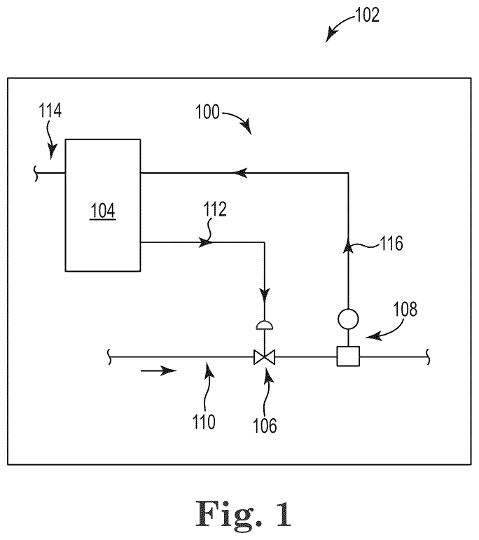

FIG. 1 provides an illustration of a control loop 100 of a chemical process 102, which includes the elements for measuring and controlling a process variable at a desired set point. Process variables can include, for example, a flow rate, a level, a pressure or a temperature among other process variables that need to be controlled in a chemical process. For the present example, the control loop 100 includes a controller 104, a flow control valve 106 and flow transmitter 108, both of which are integrated into a process fluid flow line 110. The flow control valve 106 under the control of the controller 104 can change the valve stem position to adjust the fluid flow through the process fluid flow line 110. An example of the controller 104 can include, among others, a programmable proportional-integral-derivative (PID) controller as is known in the art. The controller 104 provides a controller output (CO) signal 112 to the flow control valve 106 that allows for any number of valve positions (e.g., 0 to 100% open).

In operation, the CO signal 112 is received from the controller 104 to control the position of the control valve in the chemical process. For example, the CO signal 112 received from the controller 104 sets the position of the valve stem based on the set point (SP) signal 114. For the various embodiments, the SP signal 114 can be received by the controller 104 either manually or cascaded from another source. Fluid flow through process fluid flow line 110 in the present example is measured at the flow transmitter 108, which provides a process variable (PV) signal 116 to the controller 104. As the chemical process is typically a continuous process, each of the CO signal 112, the SP signal 114 and the PV signal 116 can provide a multivariate time series of data from the control loop 100 for the control valve (e.g., flow control valve 106) of the chemical process.

When a control loop (e.g., control loop 100) performs properly, it operates to automatically adjust the value of the PV to equal the value of the desired SP. However, when a control loop performs poorly (e.g., there are non-linear control valve events such as oscillations in the control loops) detrimental issues can be introduced into the chemical plant that disrupt normal plant operation. Such detrimental issues can include decreased product quality, increased wear on plant equipment, increases in both energy and raw material consumption, and manual operation of the control loop. Non-linear control valve events, such as oscillations, in the control loop can result from multiple sources, such as improper control tuning, multi-loop interactions, sensor faults, external oscillatory disturbances and control valve problems. Control valve problems can include, for example, stiction, backlash, deadband, deadzone, hysteresis and saturation, which can cause the controller to move the valve stem excessively in trying to regulate the control loop.

Of the above valve issues, stiction accounts for a large percent of the control valve issues in a chemical plant. Stiction is a problem in which static friction in the valve resists proper valve movement, which in turn introduces delays between the CO signal and the movement of the valve stem position. When a control valve suffers from stiction, its stem may not move even though the CO signal keeps changing. The result is that the relationship between the CO signal and the valve stem position becomes non-linear. This situation introduces oscillations into the control loop, which impacts the control and the performance of the chemical process.

The present disclosure is directed to improvements in chemical plant operations by monitoring and assessing control loops for non-linear control valve events using the techniques described herein. Specifically, the present disclosure provide for a method and a system for identifying non-linear control valve events in a control loop of a chemical process. The non-linear control valve events are based on a predetermined feature of an RGB image, which is identified by a CNN trained to identify the non-linear control valve events. For the various embodiments, such non-linear control valve events can include valve stiction, where identifying and addressing such non-linear control valve events can help to improve chemical plant operations.

As provided herein, a method of the present disclosure includes receiving a set point (SP) signal, a process variable (PV) signal, and a controller output (CO) signal comprising a multivariate time series of data from a control loop for a control valve of a chemical process where the CO signal is received from a controller that controls a position of the control valve in a chemical process, such as seen and described in FIG. 1. The multivariate time series data coming from each of the SP signal, the PV signal and the CO signal is transformed utilizing the CWT to provide respective CWT coefficients for each of the SP signal, the PV signal and the CO signal.

The CWT of each of the above signals to provide the resulting CWT coefficients is performed in accordance with Equation #1:

$$cw t ( τ , s ) = \frac{1}{\sqrt{\vert s \vert}} {\int }_{- ∞}^{+ ∞} x ( t ) ψ ( \frac{t - τ}{s} ) dt \qquad Equation \#1$$

where τ is the translation (time shift), s is the scale, Ψ (t) is the complex conjugate of the wavelet function (the mother wavelet), and ((t−τ)/s) is the scale factor. The transform given by Equation #1 may be used to construct a representation of a signal on a transform surface. The transform may be regarded as a time-scale representation. For the various embodiments, wavelets are composed of a range of frequencies, one of which may be denoted as the characteristic frequency of the wavelet, where the characteristic frequency associated with the wavelet is inversely proportional to the scale s. One example of a characteristic frequency is the dominant frequency. Each scale of a particular wavelet may have a different characteristic frequency.

The CWT decomposes the signal using wavelets, which are generally highly localized in time. The CWT may provide a higher resolution relative to discrete transforms, thus providing the ability to garner more information from signals than typical frequency transforms such as Fourier transforms (or any other spectral techniques) or discrete wavelet transforms. CWTs allow for the use of a range of wavelets with scales spanning the scales of interest of a signal such that small scale signal components correlate well with the smaller scale wavelets and thus manifest at high energies at smaller scales in the transform. Likewise, large scale signal components correlate well with the larger scale wavelets and thus manifest at high energies at larger scales in the transform. Thus, components at different scales may be separated and extracted in the wavelet transform domain. Moreover, the use of a continuous range of wavelets in scale and time position allows for a higher resolution transform than is possible relative to discrete techniques.

Using the CWT coefficients of the signals, as provided herein, a scalogram can be created, which provides a visualization of the energy of the signal in time and frequency and allows for the distinction between varying types of a signal, including the non-linear control valve events discussed herein. For the various embodiments, a variety of suitable wavelet functions may be used in connection with the present disclosure. Preferably, the Morlet wavelet is used with the present disclosure, where this wavelet is a complex wave within a scaled Gaussian envelope.

For the various embodiments, the respective CWT coefficients are assembled into respective matrices, where the respective matrices are merged to provide a red, green and blue (RGB) image. For example, the values of the matrices can be transformed onto an RGB color matrix to generate the RGB image. For example, a Gramian Angular Field can be used to accomplish generating the RGB image, where the matrices are first transformed into a GAF image and the coordinates are mapped by a polar ordinate system so that the GAF represents a temporal correlation between each time point in the time series data. The GAFs can be combined into one larger image where the values are transformed into an RGB color matrix. The RGB image provides a three channel representation for each of the signals that can be analyzed by the CNN. As discussed herein, the CNN is a deep learning algorithm that can take an input image and differentiate and assign importance to various aspects of the image through learnable weights and biases. For the various embodiments, the RGB image is inputted into the CNN trained to identify a non-linear control valve event in the control loop of the chemical process based on a predetermined feature of the RGB image. In response to the CNN identifying the predetermined feature, a setting of the controller is adjusted to eliminate the non-linear control valve event. As discussed herein, operations can be notified about the controller abnormality, whereupon adjustments to the settings of the controller can be undertaken to minimize and/or to eliminate the non-linear control valve event. In addition, identifying the control valve issue allows for an investigation into the root cause of the non-linear control valve event (e.g., a stiction problem) to be undertaken for subsequent correction.

For the various embodiments, the CNN involves the use of a convolution operation, which is a linear operation that involves the multiplication of a matrix of weights, referred to as a filter or a kernel, with the matrix of the RGB image. The kernel is applied systematically to each overlapping part or filter-sized patch of the input data (the channels of the RGB image for the signals), left to right, top to bottom. In this way the convolutional layers in the CNN systematically apply learned kernels to input images in order to create feature maps that summarize the presence of those features in the input. The convolutional layer can perform a dot product of the convolution kernel with an input matrix of the layer to produce an intermediate result. The kernel can be transposed and individually all corresponding values can be multiplied and added together. Collectively, the intermediate results form a result (e.g., feature map) that can be an input to the next layer. For each window in the input, there are multiple kernels, so the final result can provide the three channel representation.

The CNN also involves pooling of the convolution layers to help down sample features in the layers. Two common pooling methods are average pooling and max pooling that summarize the average presence of a feature and the most activated presence of a feature respectively, where max pooling is preferred. The result of using a pooling layer after the convolutional layer (often repeated multiple times) is to create down sampled or pooled feature maps, which summarize the features detected in the input. A fully connected layer may also be added to learn the non-linear control valve events provided herein. Examples of CNN useful for the present disclosure include LeNet, AlexNet, VGGNet, GoogLeNet, ResNet and ZFNet, among others.

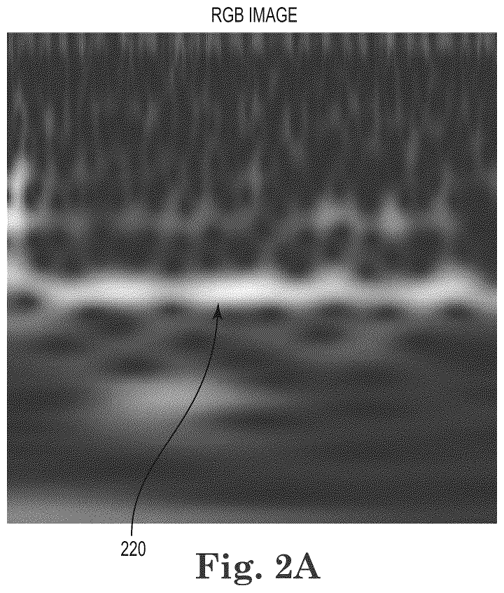

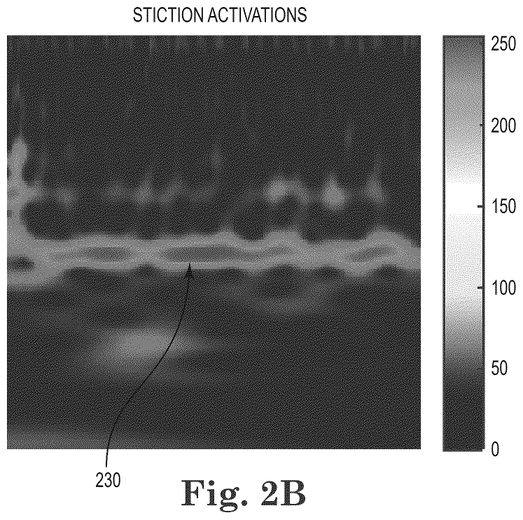

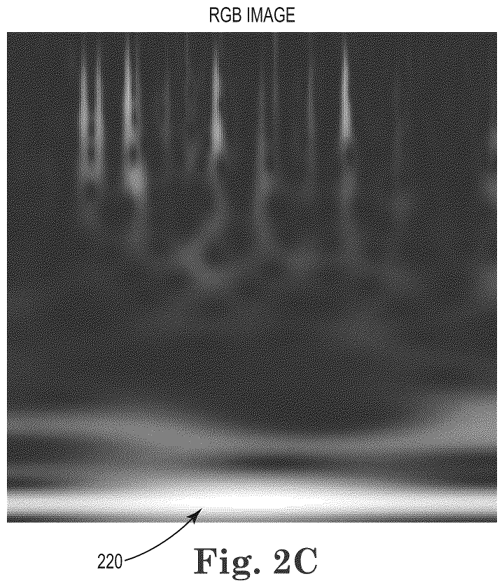

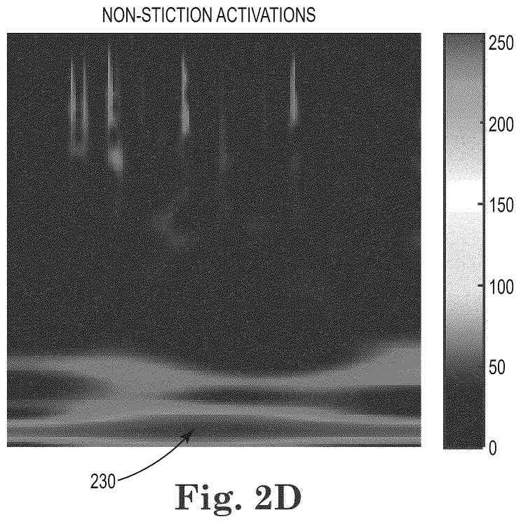

For the various embodiments, the predetermined feature of the RGB image identified by the CNN as being a non-linear control valve event can be used to identify the control valve producing the non-linear control valve event. For the various embodiments, the CWT transformation of the SP, PV, and OP signals creates a unique RGB image as illustrated in FIG. 2A (RGB Image depicting valve stiction) and FIG. 2C (RGB Image depicting non-valve stiction) for stiction and non-stiction control loop cases respectively. The magnitude of the CWT coefficients results in the variability of the color and pattern intensity of the image in each of FIG. 2A and FIG. 2C, respectively, where the differences are illustrated in FIG. 2A and FIG. 2C at 220. The CWT transformation seen in FIGS. 2A and 2C are then processed in the CNN through trained filters and layers to provide a feature map that are illustrated in FIGS. 2B and 2D. The final classification score related to stiction or non-stiction is computed using a softmax activation function that follows the final fully connected layer in the neural network. The final decision comes from the highest classification score or highest likelihood that an observation belongs to a particular class. The CNN identifies inconsistencies in the intensity and overlap of the image to decide if a control loop has valve stiction characteristics as illustrated in the CNN feature map in FIG. 2B (information detected by the CNN network to identify stiction) and FIG. 2D (information detected by the CNN network to identify non-stiction) for control loops with stiction and non-stiction respectively. The differences in the intensity are identified by the CNN (e.g., at 230) and these areas are the regions where the CWT information from the three signals overlaps or deviates. The intensity of these activations are used to decide whether a control loop expresses stiction or non-stiction. Valves displaying stiction, where PV does not track output well, show a different intensity and combined color profile from when stiction is absent as illustrated in FIG. 2B and FIG. 2D.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method, comprising:
receiving a set point (SP) signal, a process variable (PV) signal, and a controller output (CO) signal comprising a multivariate time series of data from a control loop for a control valve of a chemical process;
wherein the CO signal is received from a controller that controls a position of the control valve;
transforming the multivariate time series data coming from each of the SP signal, the PV signal and the CO signal utilizing a continuous wavelet transform (CWT) to provide respective CWT coefficients for each of the SP signal, the PV signal and the CO signal;
assembling the respective CWT coefficients into respective matrices;
merging the respective matrices to provide a red, green and blue (RGB) image;
inputting the RGB image into a deep convolutional neural network (CNN) trained to identify a non-linear control valve event in the control loop of the chemical process based on a predetermined feature of the RGB image; and
adjusting a setting of the controller to minimize the non-linear control valve event in response to the CNN identifying the predetermined feature.

2. The method of claim 1, wherein multivariate time series of data is taken at a predetermined frequency over a predetermined time interval.

3. The method of claim 2, wherein the non-linear control valve event is an oscillation event.

4. The method of claim 1, wherein a Morlet wavelet is used in transforming the multivariate time series data utilizing the CWT.

5. The method of claim 4, wherein the CNN identifies the predetermined feature based on changes in frequency information from the time series multivariate signals.

6. The method of claim 5, wherein the predetermined feature of the RGB image is related to dynamical frequency spectrum activations identified by the CNN once the non-linear control valve event is identified.

7. The method of claim 6, wherein the CNN is pretrained to identify the nonlinear control valve event in the RGB image; and
wherein the method further comprises training the CNN via transfer learning with a plurality of RGB images of comparisons of at least one pair of the SP signal, the PV signal and the CO signal of the multivariate time series of data for the controller from prior identified non-linear control valve events of the controller in the plurality of RGB images.

8. The method of claim 1, wherein the non-linear control valve event is the result of the controller being in a state of stiction.

9. The method of claim 1, wherein the controller is a flow controller in the control loop of the chemical process.

10. The method of claim 1, wherein the controller could be a level, a flow, a pressure or a temperature controller in the control loop of the chemical process.

11. The method of claim 1, wherein transforming the comparison of at least one pair of the SP signal, the PV signal and the CO signal of the multivariate time series of data comprises transforming the multivariate time series of data without preprocessing the multivariate time series of data.

12. A system, comprising:
a detector configured to:
receive a set point (SP) signal, a process variable (PV) signal, and a controller output (CO) signal comprising a multivariate time series of data from a control loop for a control valve of a chemical process;
a deep convolutional neural network (CNN) trained with a plurality of RGB images of comparisons of at least one pair of the SP signal, the PV signal and the CO signal of the multivariate time series of data for the controller from prior identified non-linear control valve events of the controller in the plurality of RGB images; and
a controller coupled to the detector and to the CNN, wherein the controller is configured to:
convert the least one pair of the SP signal, the PV signal and the CO signal of the multivariate time series of data to a RGB image utilizing a continuous wavelet transform;
input the RGB image to the CNN;
identify a non-linear control valve event of the controller with the CNN; and
adjust the setting of the controller to eliminate the non-linear control valve event of the
controller identified by the CNN.

13. The system of claim 12, wherein the controller is selected from a flow controller and a level controller.

14. The system of claim 12, wherein the non-linear control valve event is the result of the controller being in a state of stiction.

15. The system of claim 14, wherein the controller is configured to convert the multivariate time series of data to the RGB image without preprocessing the multivariate time series of data.
